(19) United States
(12) Patent Application Publication
(10) Pub. No.: US 2010/0174674 A1
(43) Pub. Date: Jul. 8, 2010

(54) ACTION RECOGNITION APPARATUS, ACTION RECOGNITION SYSTEM, AND ACTION RECOGNITION METHOD

(75) Inventors: Munetoshi Unuma, Hitachinaka (JP); Shinya Yuda, Hitachi (JP); Kenji Akagi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi-GE Nuclear Energy, Ltd.

(21) Appl. No.: 12/647,001

(22) Filed: Dec. 24, 2009

(30) Foreign Application Priority Data
Dec. 24, 2008 (JP) 2008-328404

(51) Int. Cl. G06N 5/02; G08B 23/00

(52) U.S. Cl. 706/54; 340/573.1

(57) ABSTRACT

An action recognition apparatus includes: an action detection unit for detecting an action of a subject to be recognized; an estimation processing unit for previously narrowing down action types of which actions of the subject is to be recognized; a selection processing unit for selecting a recognition method and a dictionary by referencing a recognition method/dictionary database, based on the action types narrowed down by the processing unit; and a recognition processing unit for performing an action recognition using the recognition method and the dictionary selected by the selection processing unit. The recognition processing unit performs an action recognition processing of information detected by the action detection unit, based on only the action types narrowed down by the estimation processing unit.

### CROSS REFERENCE TO RELATED APPLICATIONS

This application claims the benefit of Japanese Patent Application No. 2008-328404 filed on Dec. 24, 2008, the disclosure of which is incorporated herein by reference.

### BACKGROUND OF THE INVENTION

1. Field of the Invention

The present invention relates to an action recognition apparatus, an action recognition system, and an action recognition method.

2. Description of the Related Art

Techniques of automatically recognizing an action of a subject by sensor measurement have been known. See, for example, Japanese Laid-Open Patent Application, Publication No. H10-113343 (to be referred to as “JP H10-113393” hereinafter), paragraph [0028] and FIG. 1; Japanese Laid-Open Patent Application, Publication No. 2008-165277, paragraphs [0005] to [0015], FIG. 1, and FIG. 2; Japanese Laid-Open Patent Application, Publication No. 2008-33544, FIG. 1 and FIG. 6; Japanese Laid-Open Patent Application, Publication No. 2007-310658, paragraphs [0025] and [0028] to [0032], FIG. 2, FIG. 8, and FIG. 12; Japanese Laid-Open Patent Application, Publication No. 2006-209468, paragraphs [0008] to [0015], FIG. 1, FIG. 2, and FIG. 3; Japanese Laid-Open Patent Application, Publication No. 2006-157463, paragraph [0008] and FIG. 1.

The term “subject” used herein means a human, an animal, a machine, or any other object whose state changes. The term “action” used herein means a state in which the subject is moving or changing.

JP H10-113343 discloses a technique as follows. A subject 9 is equipped with, for example, an action detection sensor 81 in the hip, arm, or any other body part which makes a characteristic movement, as shown in FIG. 19. A recognition processing unit 82 set in an action recognition apparatus 8 obtains acceleration information which is information on acceleration applied to a body of the subject 9 from the action detection sensor 81, references a dictionary database 83 using the acceleration information, and recognizes a movement or an action of the subject 9 based on a predetermined recognition method.

The recognition processing unit 82 recognizes an action of the subject 9 by, for example, utilizing a recognition method using frequency analysis and referencing the dictionary database 83 in which frequency characteristics corresponding to action types (for example, walking) to be recognized of the subject 9. A result of the recognition is outputted to the outside via a recognized result output unit 84.

If the technique disclosed in JP H10-113343 is applied to a case where an action type to be recognized is only “walking”, an action recognition can be realized with a sufficient accuracy for practical use.

However, if the number of action types to be recognized is increased, those similar to “walking” are also likely to be increased. If such action types having similar characteristic amounts are registered in a database as a dictionary, less difference between the similar action types can result in less accuracy of recognition.

In that case, a recognition algorithm may be improved in order to enhance accuracy of recognition. This requires, however, an advanced recognition technique for recognizing a specific action type from among the action types having similar characteristic amounts, thus increasing load of calculation. If all actions made by the subject 9 are to be recognized, a large amount of action types to be recognized make a dictionary enormous. Further, if a difference in characteristic amounts is small, accuracy of recognition is lowered and a recognition algorithm becomes complicated as described above.

In light of the background, the present invention has been made in an attempt to provide an action recognition apparatus, an action recognition system, and an action recognition method, in each of which, even if the number of action types to be recognized is increased, accuracy of the recognition can be prevented from lowering in spite of existence of many similar action types.

### SUMMARY OF THE INVENTION

In an action recognition apparatus, an action recognition system, and an action recognition method, action types to be recognized are narrowed down prior to a recognition processing; a dictionary and a recognition method for recognizing an action is selected, based on the narrowed-down action types; and then, an action recognition is performed.

Other features and advantages of the present invention will become more apparent from the following detailed description of the invention, when taken in conjunction with the accompanying exemplary drawings.

### BRIEF DESCRIPTION OF THE DRAWINGS

FIG. 1 is a functional block diagram illustrating a configuration example of an action recognition apparatus according to a first embodiment.

FIG. 2 is a flowchart illustrating a recognition processing performed by a recognition processing unit of the action recognition apparatus according to the first embodiment.

FIG. 3A and FIG. 3B are graphs each illustrating an example of a data structure of a recognition method/dictionary database according to the first embodiment.

FIG. 4 is a flowchart illustrating another recognition processing performed by the recognition processing unit of the action recognition apparatus according to the first embodiment.

FIG. 5A and FIG. 5B are views each illustrating a processing result of pattern matching performed by the recognition processing unit according to the first embodiment.

FIG. 6 is a flowchart illustrating operations performed by the action recognition apparatus according to the first embodiment.

FIG. 7A and FIG. 7B are views each illustrating an example of a recognition result outputted from a recognized result output unit according to the first embodiment.

FIG. 8 is a functional block diagram illustrating a configuration of an action recognition system according to a second embodiment.

FIG. 9 is a view illustrating an example of a data structure of work instruction information stored in a work instruction information database according to the second embodiment.

FIG. 10 is a view illustrating an example of a data structure of a correspondence database according to the second embodiment.

FIG. 11 is a view illustrating an example of an action type recognized by a recognition processing unit and outputted by a recognized result output unit according to the second embodiment.

FIG. 12 is a functional block diagram illustrating a configuration of an action recognition system according to a third embodiment.

FIG. 13 is a view illustrating an example in which positional information is obtained from a position detection device according to the third embodiment.

FIG. 14A and FIG. 14B are views each illustrating an example of a data structure of a correspondence database according to the third embodiment.

FIG. 15 is a view illustrating another example in which the positional information is obtained using another position detection device according to the third embodiment.

FIG. 16 is a functional block diagram illustrating an action recognition system according to a fourth embodiment.

FIG. 17 is a flowchart illustrating operations of the action recognition system according to the fourth embodiment.

FIG. 18 is an operation conceptual diagram illustrating work contents according to the fourth embodiment.

FIG. 19 is a block diagram illustrating a configuration of an action recognition apparatus according to the prior art.

### DETAILED DESCRIPTION OF THE EXEMPLARY EMBODIMENTS

Exemplary embodiments for carrying out the present invention are described next in detail with reference to the related drawings according to the necessity.

### First Embodiment

FIG. 1 is a functional block diagram illustrating a configuration example of an action recognition apparatus 1a according to a first embodiment.

In FIG. 1, an action recognition apparatus 1a according to the first embodiment includes a control unit 10, a storage unit 20, an input unit 30, and an output unit 40.

The control unit 10 narrows down action types to be recognized, selects a dictionary and a recognition method for recognizing an action based on the narrowed-down action types, and performs an action recognition. The control unit 10 includes an estimation processing unit 11a, a selection processing unit 12, an action detection unit 13, a recognition processing unit 14, and a recognized result output unit 15.

Functions of the control unit 10 are embodied by, for example, developing and executing a program stored in the storage unit 20 of the action recognition apparatus 1a, in a RAM (Random Access Memory) by a CPU (Central Processing Unit).

The estimation processing unit 11a narrows down action types to be recognized and transfers the narrowed-down action types to the selection processing unit 12. In the action recognition apparatus 1a according to the first embodiment, an operator in charge of controlling a work narrows down the action types to be recognized via the input unit 30 and obtains information on the narrowed-down action types.

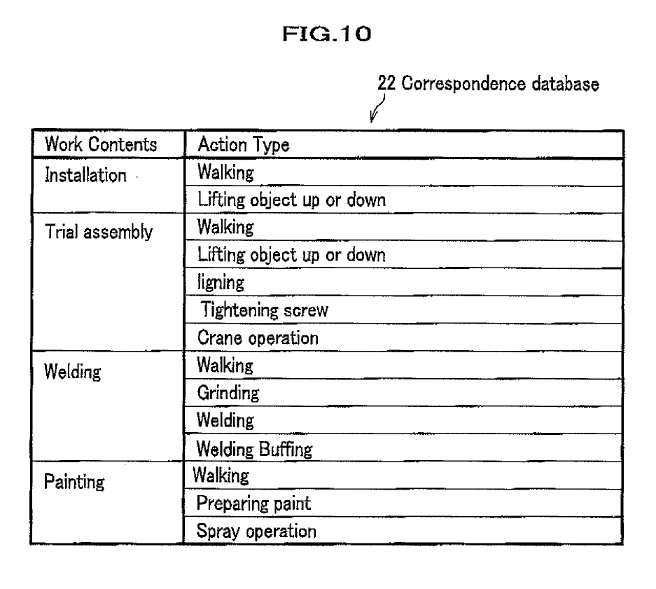

Based on the action types narrowed down by the estimation processing unit 11a, the selection processing unit 12 selects a dictionary to be referenced and a recognition method to be implemented by the recognition processing unit 14 from a recognition method/dictionary database 21 stored in the storage unit 20 and transfers the dictionary and the recognition method to the recognition processing unit 14. The term “action type” used herein means, for example, if contents of a work is an “installation”, an element of an action taken by a subject and characterizing the work contents, such as “walking” and “taking object in and out”, or the like (see FIG. 10 to be described later). The recognition method to be recognized herein is not limited to one, and a plurality of recognition methods combined can also be used.

The action detection unit 13 is wiredly or wirelessly connected to an action detection sensor (not shown) attached to an arm, a waist, or any other parts of a subject (herein, an operator) whose action is a target of recognition. The action detection unit 13 obtains information detected by the action detection sensor. The action detection sensor is not limited to an acceleration sensor, but may be, for example, an angular velocity sensor, a position sensor, a displacement sensor, or any other sensor as long as it can measure an amount of physical change caused by movements of the subject's body. Further, the action detection sensor may have a memory therein. This allows the action detection unit 13 to obtain information stored in the memory from the input unit 30.

Description herein is made assuming that a well-known three-axis acceleration sensor is used as the action detection sensor. The three-axis acceleration sensor detects a force applied to a built-in spindle using strain sensors in the X, Y, and Z directions and measures an amount of acceleration using the obtained strain values.

The recognition processing unit 14 performs an action recognition processing based on the acceleration information of a subject's action detected by the action detection unit 13, according to the dictionary and the recognition method corresponding to the action types and selected by the selection processing unit 12. The recognition processing unit 14 then outputs the recognized information to the recognized result output unit 15.

The recognized result output unit 15 transfers the information on the recognized action type which is outputted as a result of the action recognition processing by the recognition processing unit 14, to the output unit 40.

The storage unit 20 is embodied by a hard disk, a flash memory, or the like. The storage unit 20 stores therein a recognition method/dictionary database 21.

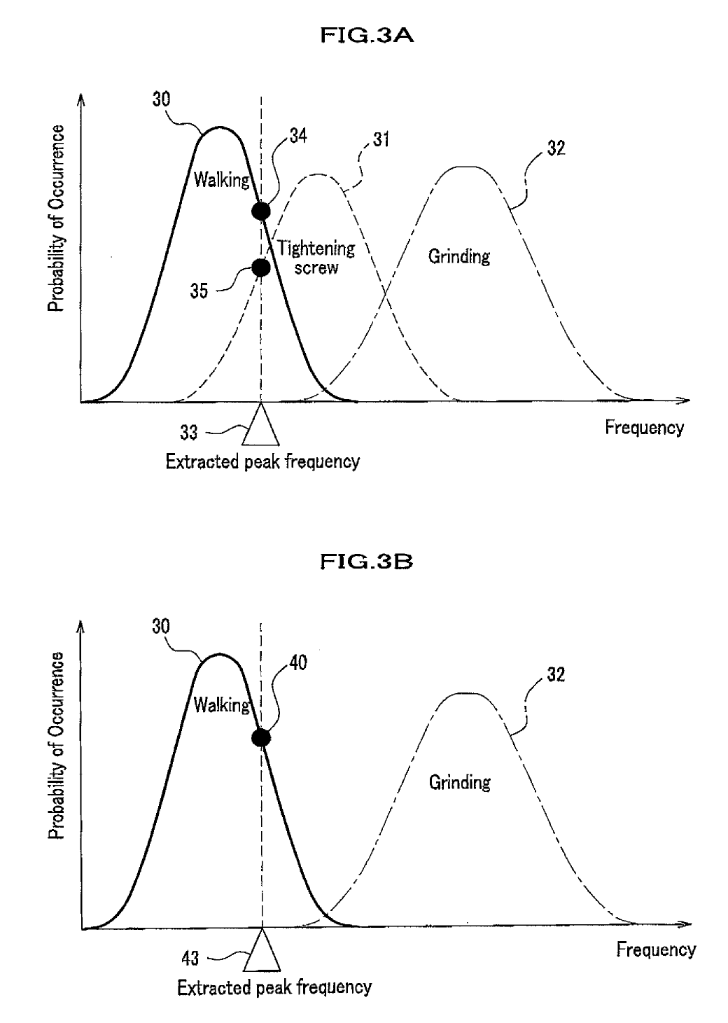

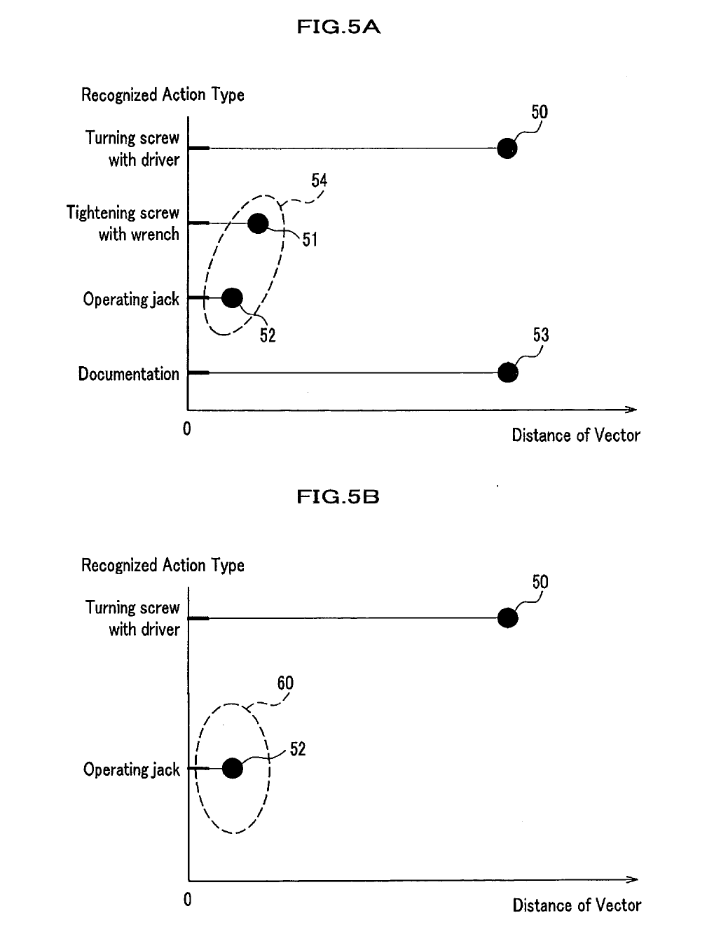

The recognition method/dictionary database 21 stores therein a method of recognizing information obtained from an action detection sensor and a dictionary including information on characteristics of each action type to be referenced, corresponding to the recognition method. In the first embodiment, the recognition method/dictionary database 21 stores therein, for example, a method of recognizing data on acceleration such as frequency analysis, pattern matching, acceleration dispersion, and inclination angle, and information on characteristics of each action type to be referenced, corresponding to the recognition method (see FIG. 3 and FIG. 5 to be described later).

The input unit 30 is embodied by a keyboard, a touch panel, a memory card reader, or the like, into which information from the outside is inputted.

The output unit 40 is embodied by a display device for displaying a result of an action recognition processing, such as a liquid crystal display monitor, a drive device for outputting the processing result as information to an external storage medium, or the like.

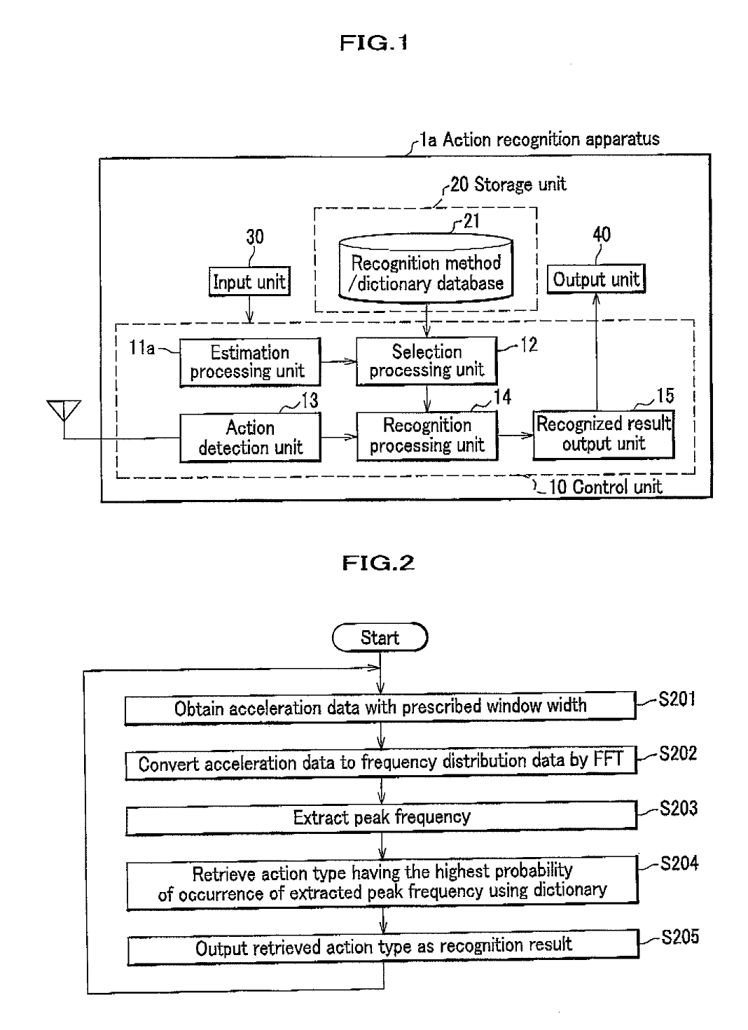

Next is described a processing performed by the action recognition apparatus la according to the first embodiment with reference to FIG. 2 to FIG. 7 as well as FIG. 1.

FIG. 2 is a flowchart illustrating a recognition processing performed by the recognition processing 14 of the action recognition apparatus la according to the first embodiment.

Description herein is made assuming that a three-axis acceleration sensor is attached to a right arm of a subject, and information is obtained by the action detection unit 13 by recognizing an action of the subject based on acceleration changes in the subject's right arm by FFT (Fast Fourier Transform), which is one of the recognition methods using frequency analysis.

As shown in FIG. 2, the recognition processing unit 14 obtains data on acceleration collected by the action detection unit 13 in time series with an interval of a prescribed window width (which is a unit of a processing of frequency transform determined by, for example, dating back from the present moment for a prescribed time period) (step S201).

The recognition processing unit 14 converts the obtained acceleration data from the time series data to frequency distribution data by means of FFT (step S202). The recognition processing unit 14 then extracts a peak frequency from the converted frequency distribution data (step S203). The extracted peak frequency is a characteristic amount of the acceleration data obtained in step S201 in time series.

The recognition processing unit 14 retrieves an action type having the highest probability of occurrence of the extracted peak frequency using the recognition method/dictionary database 21 (step S204). The recognition processing unit 14 outputs the retrieved action type to the recognized result output unit 15 as a recognized result (step S205).

FIG. 3A and FIG. 3B are graphs each illustrating an example of a data structure of the recognition method/dictionary database 24 according to the first embodiment. In each of FIG. 3A and FIG. 3B, the horizontal axis shows frequency, and the vertical axis, the probability of occurrence. In FIG. 3A, a curve 30 represents a probability of occurrence of an action type “walking”; a curve 31, “tightening screw”; and a curve 32, “grinding”. The respective curves 30 to 32 with different action types have different frequency characteristics in the probability of occurrence.

In FIG. 3A, if the peak frequency extracted in step S203 of FIG. 2 is in a position indicated by an arrowhead 33, the probability of occurrence of the action type “walking” has a value specified by a filled circle 34, and, of the action type “tightening screw”, a value specified by a filled circle 35. Of the three action types, the “walking” has the highest probability of occurrence. However, frequencies indicated by the filled circles 39 and 35 are positioned close to each other. This suggests that, if the peak frequency goes up even a little higher, the probability of occurrence of the action type “tightening screw” becomes higher than that of the “walking”.

This is the problem occurred in a conventional action recognition apparatus. If a plurality of action types have similar characteristic amounts, the conventional action recognition apparatus has disadvantageously mixed recognition results, thus lowering accuracy of the recognition. For this reason, the action recognition apparatus 1a according to the first embodiment can narrow down the number of action types to be recognized by removing an unrelated action type which has a similar characteristic amount prior to an action recognition processing.

For example, if which work an operator as a subject carries out and that the work does not include the “tightening screw” is previously known, the action type “tightening screw” is omitted from action types to be recognized.

FIG. 3B shows an example of a dictionary referenced in a case where the “tightening screw” is omitted from the action types to be recognized.

In the action recognition apparatus 1a according to the first embodiment, if an extracted peak frequency is in a position indicated by an arrowhead 43, the filled circle 40 is in a position more clearly belonging to “walking” because the curve 31 of “tightening screw” shown in FIG. 3A is omitted. This enables the action type of the extracted peak frequency to be recognized as “walking” with a high probability. Note that the selection processing unit 12 narrows down the action types to be recognized using narrowed-down information inputted by the estimation processing unit 11, details of which are to be described later.

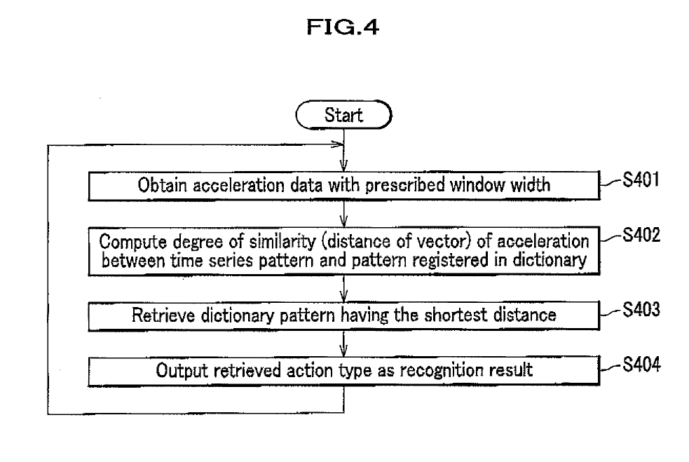

FIG. 4 is a flowchart illustrating another recognition processing performed by the recognition processing unit 14 of the action recognition apparatus 1a according to the first embodiment. In FIG. 2, description has been made assuming that the recognition processing unit 14 carries out an action recognition using the FFT. In FIG. 4, however, description is made assuming that the recognition processing unit 14 carries out an action recognition using pattern matching.

The recognition processing unit 14 obtains an acceleration data obtained from the action detection unit 13 by the prescribed window width (step S401). The obtained acceleration data in time series is referred to as I(n). The “n” is the number of the acceleration data obtained by the window width. If an acceleration sensor used has a single-axis, I(n) is represented as a vector having the element number “n”.

The recognition processing unit 14 acceleration computes a degree of similarity (a distance of the vector) of between an acceleration data of a time series pattern and a pattern registered in the recognition method/dictionary database 12 (to be described hereinafter as a dictionary pattern) (step S402). For simplification, assuming that the dictionary pattern has the same element number Pi(n) as that of the obtained acceleration data, a distance Di of the vector is indicated by Expression 1 as follows:

Di=|I(n)−Pi(n)| Expression 1

wherein “i” is a serial number of the dictionary.

The recognition processing unit 14 retrieves a dictionary pattern (i.e, an action type) having the shortest distance, using Expression 2 as follows (step S403):

W(I(n))=min Di=min|I(n)−Pi(n)| Expression 2

Herein, W(I(n)) is the shortest distance from the dictionary pattern. An action type of the dictionary pattern having the shortest distance is outputted as a result of recognition (step S404).

FIG. 5A and FIG. 5B are views each illustrating a result of a pattern matching processing performed by the recognition processing unit 14 according to the first embodiment. FIG. 5A and FIG. 5B each show a relationship of a distance of a vector between a dictionary pattern and an acceleration data obtained. In both of FIG. 5A and FIG. 5B, the horizontal axis shows the distance of a vector, and the vertical axis shows an action type retrieved by computing Expression 2.

In FIG. 5A, the action type retrieved by computing Expression 2 is an action type “operating jack” as indicated by a filled circle 52, which has the shortest distance of the vector. Meanwhile, an action type “tightening screw with wrench” indicated by a filled circle 51 has a relatively short distance. The similar distances of the filled circles 52 and 51 lead to ambiguity in determining an appropriate action type. Even in such a case, if which operation an operator as a subject carries out is previously known, the action type “tightening screw with wrench” is omitted from the action types to be recognized. Thus, the recognition processing unit 14 can securely recognize the action type “operating jack” as shown in FIG. 5B.

In the above description, Expressions 1 and 2 are exemplified assuming that, for simplification, the element number of the dictionary pattern is the same as that of the obtained acceleration data. However, the action recognition can also be made using DP (Dynamic Programming) matching or Hidden Markov model, an advanced technique of the DP matching, in which the element numbers are different.

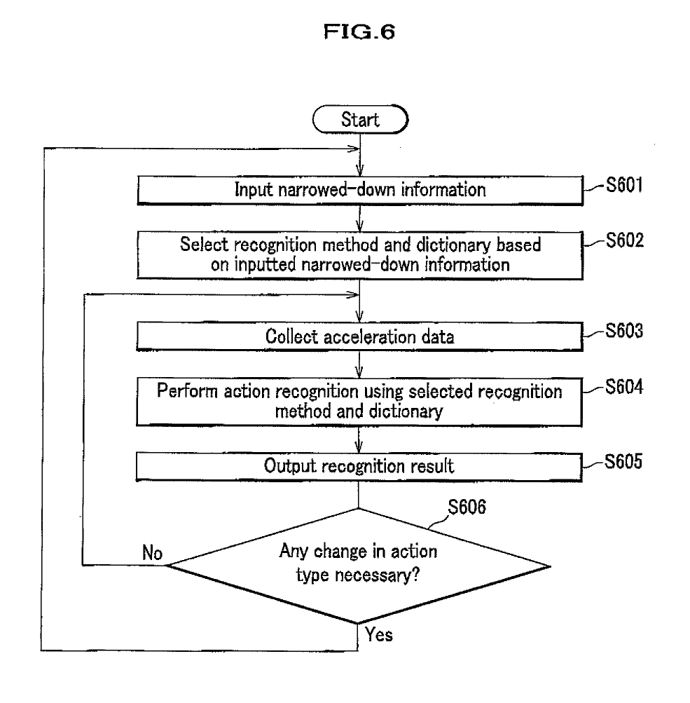

FIG. 6 is a flowchart illustrating operations performed by the action recognition apparatus la according to the first embodiment.

Next are described in detail the operations of the action recognition apparatus 1a according to the first embodiment shown in FIG. 1, with reference to FIG. 6.

For example, an operator in charge of controlling a work of interest inputs an action type as narrowed-down information into the estimation processing unit 11a via the input unit 30 (step S601). The estimation processing unit 11a transfers the narrowed-down information to the selection processing unit 12.

The operator in charge determines an operation of which action type an operator as a subject is to perform and manually inputs the determined action type by inputting appropriate data in the input unit 30 embodied by, for example, a keyboard. Instead, the operator may input schedule information based on a current time and date in cooperation with a step management system or a schedule management system to be described later. More specifically with reference to a dictionary structure of FIG. 3B, if an operator as a subject carries out only two action of which types in an operation, “walking” and “grinding”, the operator in charge inputs the two action types, “walking” and “grinding”. In another case, if an operator as a subject does not carry out an action of which type is “tightening screw”, the operator in charge inputs such narrowed-down information that “tightening screw” is omitted from among registered action types to be recognized.

The selection processing unit 12 selects a recognition method and a dictionary based on the narrowed-down information inputted by the estimation processing unit 11a (step S602). For example, as shown in FIG. 3B, if the narrowed-down information that “tightening screw” is not carried out is inputted, the selection processing unit 12 selects and references a dictionary necessary not for “tightening screw” but for “walking” and “grinding” for performing a recognition processing.

In some cases, the input of the narrowed-down information eliminates the need for a recognition processing using the pattern matching of respective action types of, for example, “turning screw with driver”, “tightening screw with wrench”, “operating a jack”, and “documentation” shown in FIG. 5A. Thus, only the recognition processing using the FFT can be performed. This can reduce a potential false recognition caused by the recognition processing using the pattern matching and also reduce load of a computing processing.

Upon selection of the recognition method and the dictionary by the selection processing unit 12, the recognition processing unit 14 obtains the corresponding appropriate recognition method and a dictionary from the recognition method/dictionary database 21 and starts collection of acceleration data from the action detection unit 13 (step S603) The recognition processing unit 14 carries out an action recognition using the selected recognition method and dictionary if the number of the collected data reaches a window width sufficient to perform a calculation (step S604).

Only selection of a dictionary has been described above. However, selection of a necessary recognition method (or a processing procedure using a plurality of recognition methods) is herein assumed to be similarly made using the narrowed-down information inputted by the estimation processing unit 11a. Such selection makes it possible to carry out an action recognition with techniques using the FFT shown in FIG. 3A and FIG. 3B or the pattern matching shown in FIG. 5A and FIG. 5B, recognition methods using the acceleration variance, principal component analysis, or the like, as well as a combination of any of the above methods.

The recognition processing unit 14 transfers a result of the action recognition to the recognized result output unit 15. The recognition processing unit 14 outputs the recognition result to a liquid crystal display monitor or the like of the output unit 40 under controls of the recognized result output unit 15 (step S605).

After the output of the recognition result, the recognition processing unit 14 determines whether or not any change in an action type to be recognized by the operator is necessary (step S606). This is because a new action type which may appear according to newly obtained acceleration data because action contents may change over time. If a change in the action types is necessary (if Yes in step S606), the processing returns to step S601 and continues an input of narrowed-down information. If a change in the action types is not necessary (if No in step S606), the processing returns to step S603 in which the recognition processing unit 14 collects and obtains acceleration data.

Next are described the recognition result which the recognized result output unit 15 of the action recognition apparatus 1a displays in the output unit 40 as shown in step S605 of FIG. 6.

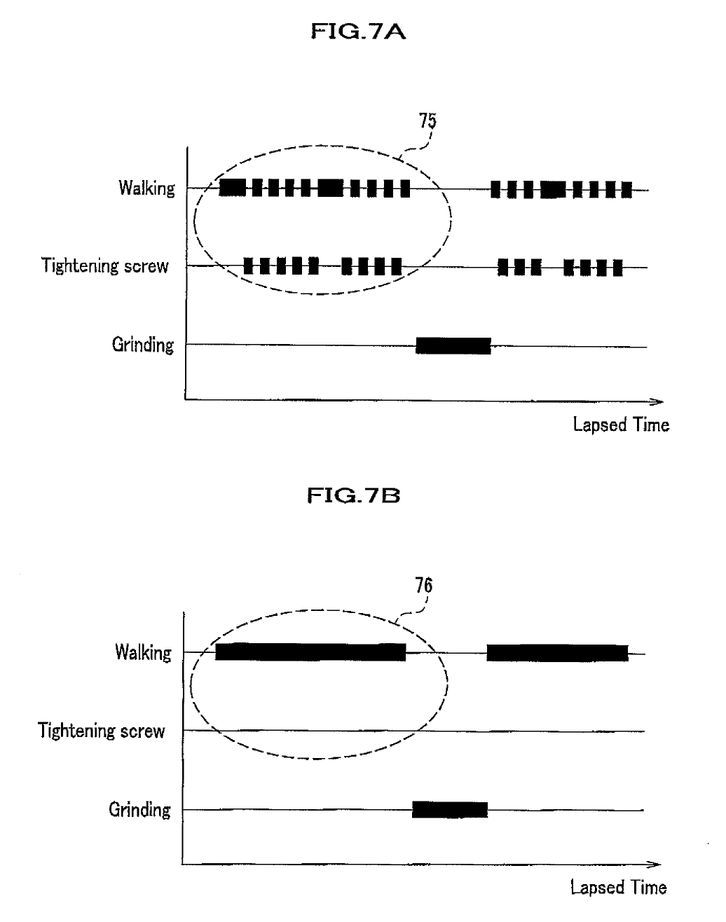

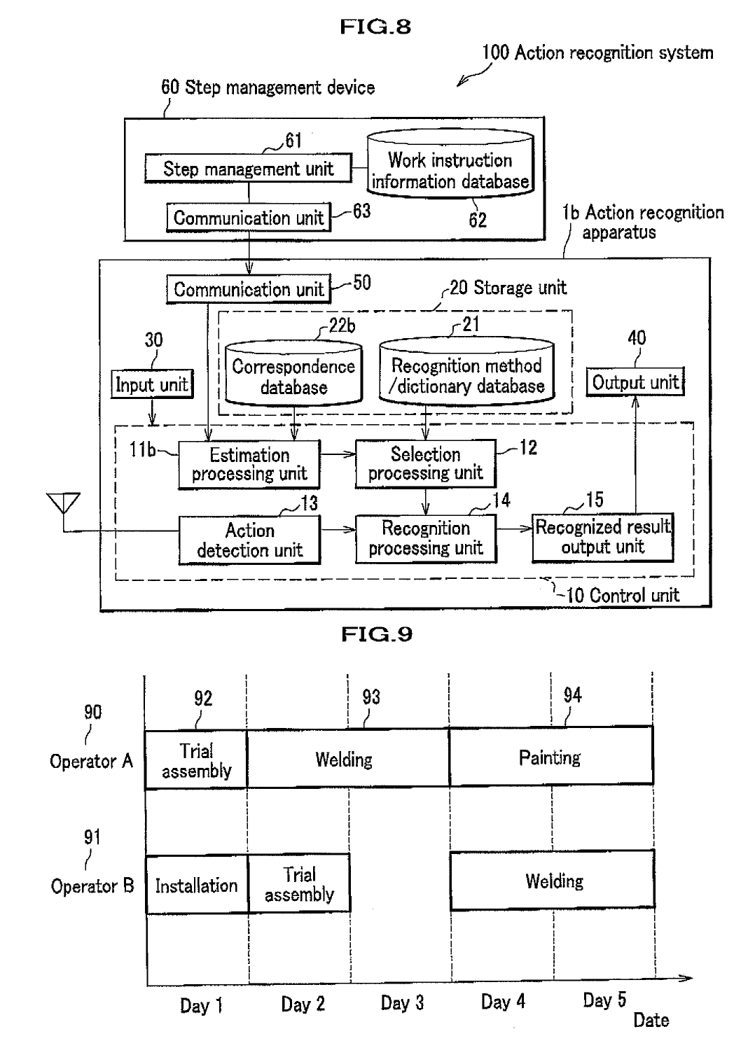

FIG. 7A and FIG. 7B are views each illustrating an example of a recognition result outputted from the recognized result output unit 15 according to the first embodiment, FIG. 7A corresponds to FIG. 3A and shows an example in which an input for narrowing down action types is not conducted. FIG. 7B corresponds to FIG. 3B and shows an example in which an input for narrowing down action types is conducted. In both FIG. 7A and FIG. 7B, the horizontal axis shows a lapsed time, and the vertical axis, an action type. Heavy black lines represent areas recognized as the action types.

In an area within a dotted circle 75 of FIG. 7A, a dictionary (frequency) of “walking” is close to that of “tightening screw” as shown in FIG. 3A. This means that a slight variation of a measurement result of acceleration data may bring different recognition results. Thus, the action recognition lacks consistency and stability, which reduces accuracy of recognition.

Meanwhile, FIG. 7B shows a case where the narrowed-down information is inputted, and the “tightening screw” is thus omitted from the action types to be recognized. An area within a dotted circle 76 can readily output a stable recognition result.

As described above, the action recognition apparatus 1a according to the first embodiment enhances accuracy of recognition by narrowing down action types to be recognized. Further, the action recognition apparatus la can reduce load of calculation because an unnecessary recognition processing can be omitted.

### Second Embodiment

FIG. 8 is a functional block diagram illustrating a configuration of an action recognition system 100 according to a second embodiment.

As shown in FIG. 8, an action recognition system 100 according to the second embodiment includes an action recognition apparatus 1b and a step management device 60.

The action recognition apparatus 1b according to the second embodiment is similar to the recognition apparatus 1a according to the first embodiment shown in FIG. 1 except that an estimation processing unit 11b narrows down action types based not on a manual input of the narrowed-down information on action types to be recognized but on work instruction information obtained from a step management device 60.

The step management device 60 includes: a work instruction information database (which may also be referred to as a schedule information database) 62 for storing steps of manufacturing a product in time series; a step management unit 61 for managing register, update, or the like of the work instruction information stored in the work instruction information database 62; and a communication unit 63 for communicating data with the action recognition apparatus 1b. The work instruction information shows a type of a work step (or work contents) outputted by the day or by the hour (see FIG. 9 to be described later).

The action recognition apparatus 1b includes a schedule correspondence database (schedule correspondence database) 22 (22b) provided in the storage unit 20, in addition to the configuration of the action recognition apparatus 1a according to the first embodiment of FIG. 1.

The correspondence database 22b stores therein a correspondence relation between work contents included in the work instruction information obtained from the step management device 60 and an action type (see FIG. 10 to be described later).

An example of the work instruction information which is managed by the step management device 60 in the work instruction information database 62 is shown in FIG. 9.

FIG. 9 is a view illustrating an example of a data structure of the work instruction information stored in the work instruction information database 62 according to the second embodiment.

As shown in FIG. 9, the step management unit 61 of the step management device 60 manages respective work schedules of an operator A designated at the reference numeral 90 and an operator B designated at the reference numeral 91 in time series.

For example, the operator A 90 has the work schedule of a trial assembly work 92 on Day 1, a welding work 93 from Day 2 to Day 3, and a painting work 94 from Day 4 to Day 5. Such a work schedule is registered in the work instruction information database 62 in time series. Note that FIG. 9 shows the work schedule of the operators. However, the data structure of the work instruction information is not limited to the aforementioned, but may be based on types of products to be manufactured.

The work instruction information is outputted by the day or the hour. For example, a work instruction to the operator A on Day 4 is a painting work. The estimation processing unit 11b references the correspondence database 22b based on the work instruction information obtained from the step management device 60 via the communication unit 63, estimates a possible action type to be performed by the operator A, and transmits the possible action type to the selection processing unit 12.

FIG. 10 is a view illustrating an example of a data structure of a correspondence database 22b according to the second embodiment.

As shown in FIG. 10, the correspondence database 22b stores therein correspondence information which indicates a correspondence between work contents shown in the work instruction information and action types (work elements) for conducting the work contents. For example, if the work instruction information shows an installation work, the correspondence information indicates two action types, “walking” and “lifting object up and down”. If the work instruction information shows a trial assembly, the correspondence information indicates that “walking”, “lifting object up and down”, “aligning”, “tightening screw”, and “crane operation” are to be performed. The estimation processing unit 11b references the correspondence database 22b based on work contents indicated by the work instruction information, estimates a possible action type to be performed, and transmits the estimated action type to the selection processing unit 12.

For example, a work to be performed by the operator A 90 on Day 4 is the painting work as shown in FIG. 9. The work corresponds to the action type “walking”, “preparing paint”, and “spray operation”, thus enabling the action types to be narrowed down. Then, similarly to the first embodiment, the processing in and after step S602 shown in FIG. 6 is performed. The processing includes the step of selecting a recognition method and a dictionary performed by the selection processing unit 12 and the step of recognizing the action type(s) narrowed down by the recognition processing unit 14.

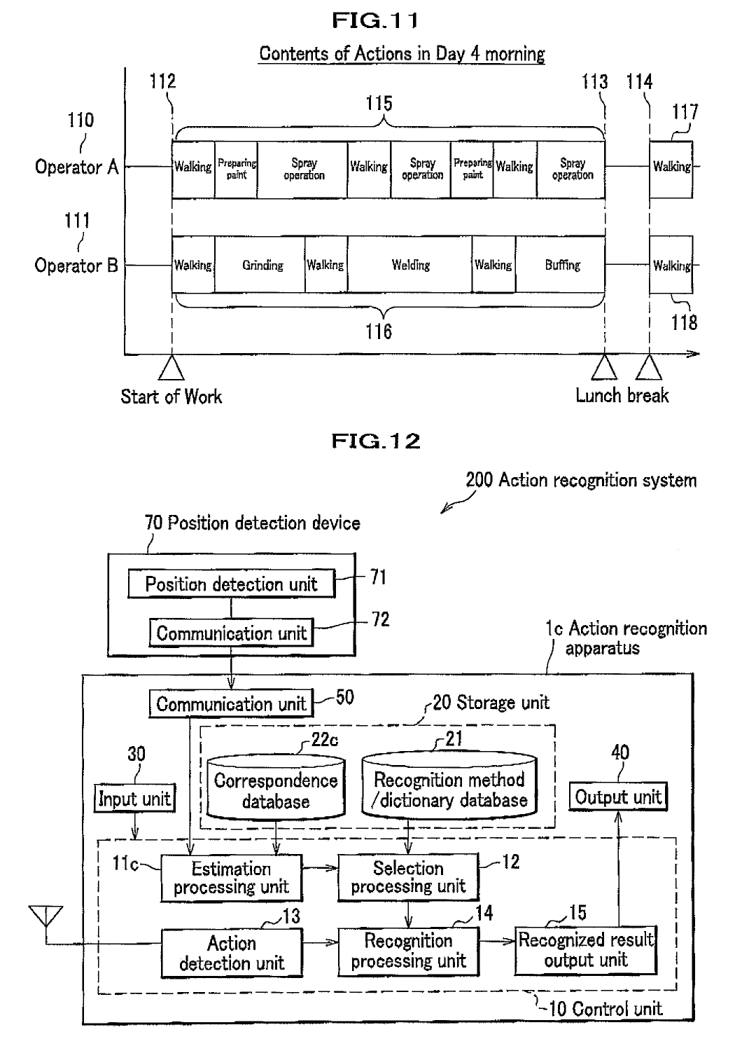

FIG. 11 is a view illustrating an example of an action type recognized by the recognition processing unit 14 and outputted by the recognized result output unit 15 according to the second embodiment.

FIG. 11 exemplifies works conducted by an operator A designated at the reference numeral 110 and an operator B designated at the reference numeral 111 in the morning on Day 4.

In FIG. 11, the work schedule of the operator A 110 on Day 4 is a painting work. Thus, the recognized result output unit 15 outputs only those related to the painting work, namely, “walking”, “preparing paint”, and “spray operation”, to which a reference numeral 115 is designated. Similarly, the work schedule of the operator B 111 on Day 4 is a welding work. Thus, the recognized result output unit 15 outputs only those related to the welding work, namely, “walking”, “grinding”, “welding”, and “buffing”, to which a reference numeral 116 is designated.

In FIG. 11, action types as a recognized result are not outputted before the start of the work designated at the reference numeral 112 and during a lunch break indicated as a period between reference numerals 113 and 114. This is because an operator during off-work periods does an action other than those previously estimated. An action type is recognized only during a prescribed period.

If recognition of action types during an off-work period is desired, the action recognition apparatus 1b registers a possible action type estimated to be made before the start of the work or during the lunch break, in the correspondence database 22b. The action recognition apparatus 1b switches action types to be recognized for each prescribed time for switching work contents, using necessary processings by the estimation processing unit 11b and the selection processing unit 12.

As described above, in the action recognition system 100 according to the second embodiment, the action recognition apparatus 1b obtains the work instruction information for scheduling work contents in time series from the step management device 60, narrows down action types to be recognized based on the correspondence database 22b, and performs a recognition processing with the narrowed-down action types. This enhances accuracy of recognition. Further, by obtaining scheduled work contents in time series from the step management device 60, the action recognition apparatus 1b can selectively switch the most suitable recognition method and dictionary at a given point of time by the selection processing unit 12 and perform a recognition processing based on the selection.

In the action recognition system 100 according to the second embodiment, workload for performing the recognition processing can be reduced, because a manual input for narrowing down action types in advance of the recognition processing is not necessary.

In the second embodiment, description has been made assuming that, in the configuration of the action recognition system 100, the action recognition apparatus 1b is separate from the step management device 60. However, another configuration is also possible. The step management unit 61 and the work instruction information database 62 of the step management device 60 may be built in the action recognition apparatus 1b, which makes a single action recognition apparatus. Such a configuration can also obtain effects and advantages similar to those in the second embodiment.

In the action recognition system 100 according to the second embodiment, the work instruction information outputted by the step management device 60 is exemplified as the schedule information. However, another configuration is also possible in which a schedule management system for managing a schedule of actions of a person or movements of an object in time series is used as the schedule information.

For example, action types may be narrowed down using a scheduler indicating that a person conducts a work at or away from office. Another way of narrowing down the action types is to obtain, from a scheduler, information on whether a person is at or away from home, or on actions outside home (e.g. workout at a gym or mountain climbing). A still another way of narrowing down the action types is to utilize schedule information which is determined regardless of a person' s schedule, such as a train timetable. Such schedule information is used to determine whether a person makes an action on a train or at a station before getting on or getting off a train.

Besides the schedule management system, the action types can also be narrowed down by using pattern information which is information on common practice of a person such as a lifestyle pattern.

For example, if the pattern information on wake-up time, bedtime, and mealtime is used, the action types can also be narrowed down by using possible actions during sleep (e.g. roll-over and breathing conditions), during meal, or the like. This allows an enhanced accuracy of recognition. During a sleep time, a recognition algorithm for recognizing actions such as roll-over and breathing (for example, a pattern recognition of sleep apnea syndrome or the like) can be used to recognize an accurate sleep period. During a meal time, a recognition algorithm for recognizing actions such as movements of chopsticks or a fork can be used to recognize an accurate meal period.

### Third Embodiment

FIG. 12 is a functional block diagram illustrating a configuration of an action recognition system 200 according to a third embodiment.

As shown in FIG. 12, the action recognition system 200 according to the third embodiment includes an action recognition apparatus 1c and a position detection device 70.

The action recognition apparatus 1 according to the third embodiment 1c is similar to the action recognition apparatus 1a according to the first embodiment shown in FIG. 1 except that the estimation processing unit 11c narrows down action type based on positional information of a subject obtained from the position detection device 70, instead of based on a manual input of the narrowed-down information of action types to be recognized.

The position detection device 70 is embodied by, for example, a device capable of detecting an absolute position on the earth as represented by the GPS (Global Positioning System), a positioning system in which a plurality of receivers receive radiowave from a transmitter and an arrival time of radiowave or a field intensity is utilized for detecting a position, a ranging system in which radiowave transmitted from a transmitter is received and a distance from the transmitter is estimated, or the like.

The position detection device 70 includes; a position detection unit 71 for detecting positional information by receiving radiowave from a transmitter attached to an operator; and a communication unit 72 for transmitting the positional information detected by the position detection unit 71, to the action recognition apparatus 1c.

The action recognition apparatus 1c also includes a correspondence database (which may also be referred to as a position correspondence database) 22c provided in the storage unit 20, in addition to the configuration of the action recognition apparatus la according to the first embodiment of FIG. 1.

The correspondence database 22c stores therein positional information obtained from the position detection device 70 and work contents in a device at a position indicated by the positional information (see FIG. 14 to be described later).

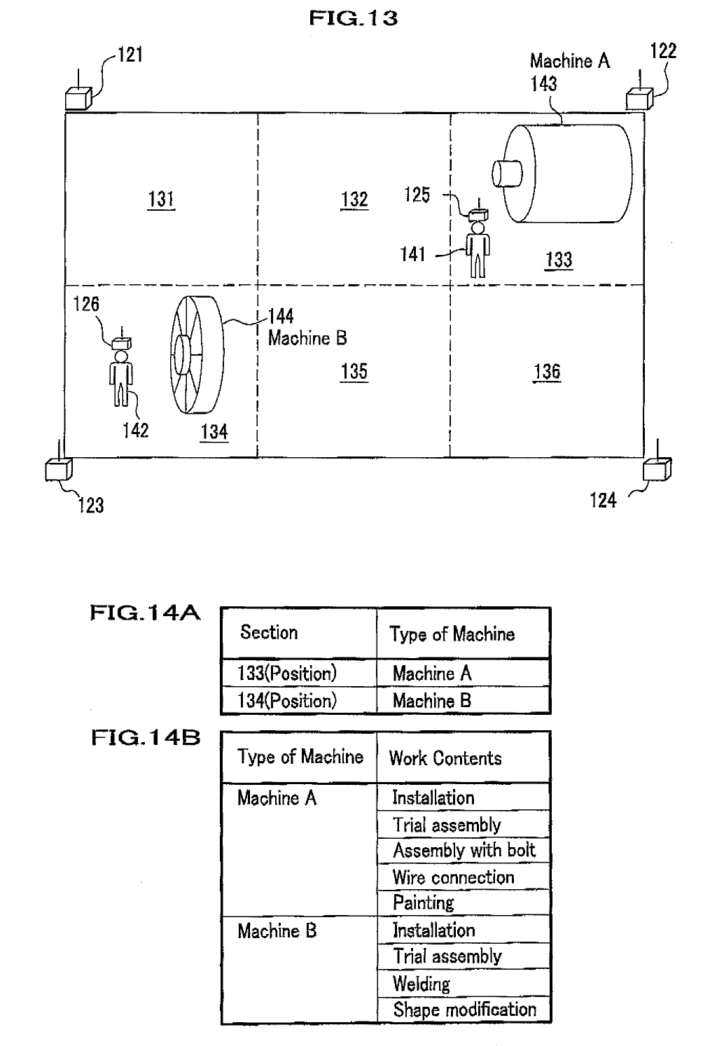

FIG. 13 is an example in which positional information is obtained from the position detection device 70 according to the third embodiment, using radiowave from a transmitter.

In FIG. 13, receivers 121 to 124 receive radiowave from a beacon. Operators 141, 142 are equipped with beacons 125, 126, respectively. A machine A 143 and a machine B 194 are under manufacturing. An area with the above-mentioned components is divided into six sections 131 to 136.

FIG. 14A and FIG. 14B are views each illustrating an example of a data structure of the correspondence database 22c.

The correspondence database 22c stores therein information indicating a correspondence relation between a type of a machine installed in the area and a section in which the machine is installed (that is, the positional information) as shown in FIG. 14A. The correspondence database 22c also stores therein information indicating a correspondence relation between a type of the installed machine and work contents for manufacturing the machine as shown in FIG. 14B. For example, work contents for manufacturing the machine A are “installation”, “trial assembly”, “assembly with bolt”, “wire connection”, and “painting”.

The correspondence database 22c stores therein, in addition to the information shown in FIG. 14A and FIG. 14B, the correspondence relation between work contents and the action types as described in the second embodiment and shown in FIG. 10.

The position detection device 70 receives radiowave transmitted from the respective beacons 125, 126 attached to the operators 141, 142, via the receivers 121 to 124, measures distances from the respective beacons 125, 126 to the receivers 121 to 124, and detects in which sections 131 to 136 each of the operators 141, 142 is present.

The estimation processing unit 11c references the correspondence database 22c based on the positional information on the operator as a subject obtained from the position detection device 70 and narrows down action types to be recognized.

For example, if the position detection device 70 detects that the operator 141 is present in the section 133, the estimation processing unit 11c references the correspondence database 22c as shown in FIG. 14A to retrieve information indicating that the machine A is installed in the section 133. This means that the operator 141 conducts a work near the machine A.

The estimation processing unit 11c references the correspondence database 22c as shown in FIG. 14B and estimates work contents of the machine A. Based on the estimated work contents, the estimation processing unit 11c further references the action types shown in FIG. 10 and estimates a possible action type to be recognized, and transfers the estimated action type to the selection processing unit 12. Then, similarly to the first embodiment, the processing in and after step S602 shown in FIG. 6 is performed. The processing includes the step of selecting a recognition method and a dictionary performed by the selection processing unit 12 and the step of recognizing the action type narrowed down by the recognition processing unit 14.

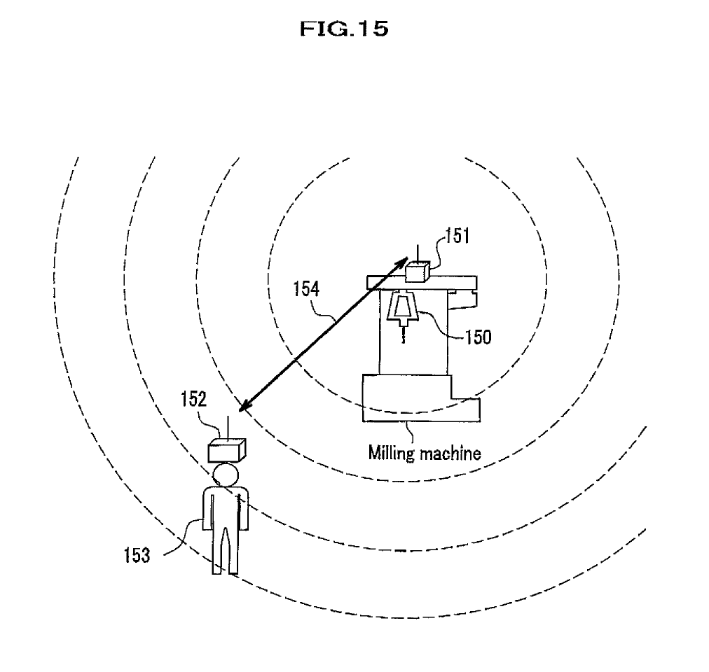

The position detection device 70 may be an position sensor shown in FIG. 15.

FIG. 15 is a view illustrating another example in which the positional information is obtained using another position detection device according to the third embodiment. In FIG. 15, position (distance) sensors 151, 152 are, for example, a transmitter and a receiver, respectively. Radiowave transmitted from the transmitter 151 is received by the receiver 152. The receiver 152 can estimate a distance 154 from the transmitter 151 by measuring a field intensity.

The example of FIG. 15 assumes a case in which the transmitter 151 is attached to a milling machine 150. If a field intensity of the radiowave received by the receiver 152 is high, an operator 153 is estimated to be near the milling machine 150. The action recognition apparatus 1c can thus narrow action types to be recognized down to those corresponding to works done with the milling machine 150.

As described above, in the action recognition system 200 according to the third embodiment, the action recognition apparatus 1c obtains positional information of a subject from the position detection device 50, narrows down action types to be recognized, based on the correspondence database 22c, and performs a recognition processing with the narrowed-down action types. This enhances accuracy of recognition.

In the action recognition system 200, an appropriate action type can be estimated, making use of a result outputted by the position detection device 70. Thus, workload for performing a recognition processing can be reduced, because a manual input for narrowing down action types in advance of the recognition processing is not necessary.

In the third embodiment, description has been made assuming that, in the configuration of the action recognition system 200, the action recognition apparatus 1c is separate from the position detection device 70. However, another configuration is also possible. The position detection unit 71 of the position detection device 70 may be built in the action recognition apparatus 1c, which makes a single action recognition apparatus. Such a configuration can also obtain effects and advantages similar to those in the third embodiment.

In the action recognition system 200 according to the third embodiment, action types are narrowed down based on a position of a machine which is present at its manufacturing site. However, action types may be narrowed down based on a place or characteristics of a machine. For example, if a position sensor is attached to a vehicle and an operator is recognized to be on the vehicle, action types can be narrowed down to those related to a vehicle operation. For another example, if a subject who is equipped with a GPS or any other position detection device is recognized to be in an amusement park, action types can be narrowed down to those related to amusement rides. This further enables to recognize on which amusement ride the subject enjoys.

In the third embodiment, description has been made assuming that actions types to be recognized of a subject are narrowed down using the positional information. In the second embodiment, meanwhile, the actions types are narrowed down using the step management (which may also be referred to as a scheduler). However, both the scheduler and the positional information may be used for narrowing down the actions types. This allows the action types to be further narrowed down, enhances accuracy of recognition by the recognition processing unit 14, and reduces load of calculation.

### Fourth Embodiment

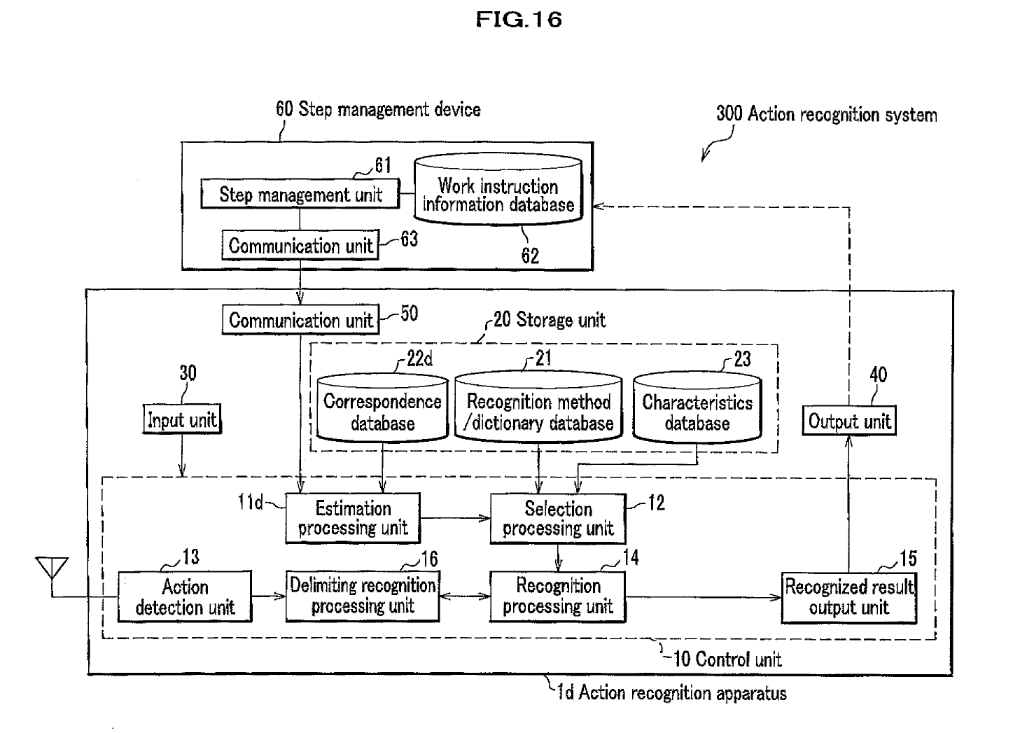

FIG. 16 is a functional block diagram illustrating a configuration of an action recognition system 300 according to a fourth embodiment.

As shown in FIG. 16, the action recognition system 300 according to the fourth embodiment includes an action recognition apparatus 1d and a step management device 60.

The action recognition apparatus 1d according to the fourth embodiment is similar to the action recognition apparatus 1b according to the second embodiment of FIG. 8 except that the work instruction information is outputted by the step management device 60 not on a single-work basis but on a plural-works basis (for example, a plurality of work contents done in one day). If the work instruction information on the plural-works basis is used, a recognition processing is performed after detecting from what time to what time each work of the plural works has been done, that is, how an entire time period of the plural works is delimited by each work. Such information is necessary for narrowing down action types.

In order to narrow down action types, the action recognition apparatus 1d has a configuration in which a time for delimiting each work is detected, after which action types of the each work are narrowed down. For this purpose, the action recognition apparatus 1d includes: a characteristics database 23 provided in the storage unit 20; and a delimiting recognition processing unit 16 provided in the control unit 10, in addition to the configuration of the action recognition apparatus 1b according to the second embodiment.

The characteristics database 23 stores therein a characteristic action type of each work. For example, if the work contents is polishing, the characteristics database 23 stores therein “grinder” which is a characteristic action representative of the polishing.

The delimiting recognition processing unit 16 detects delimiting of consecutive works, using a characteristic action type stored in the characteristics database 23 and schedule information for scheduling work contents in time series. Details of the delimiting recognition processing unit 16 are described later.

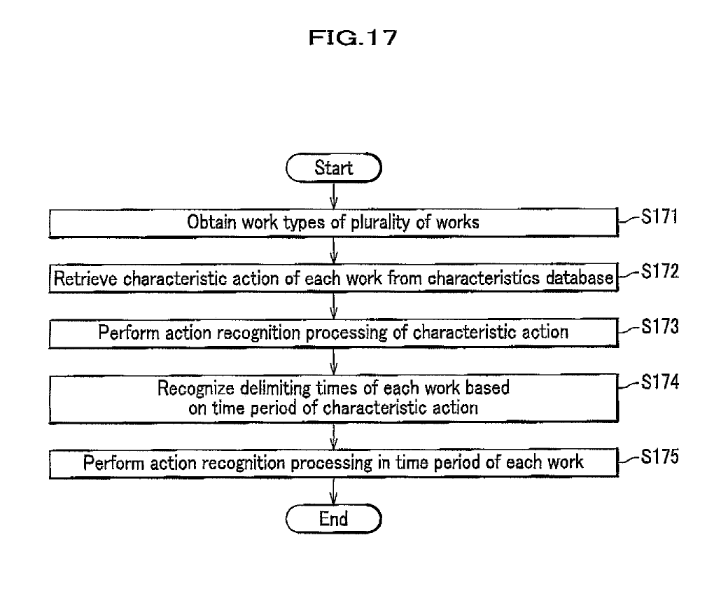

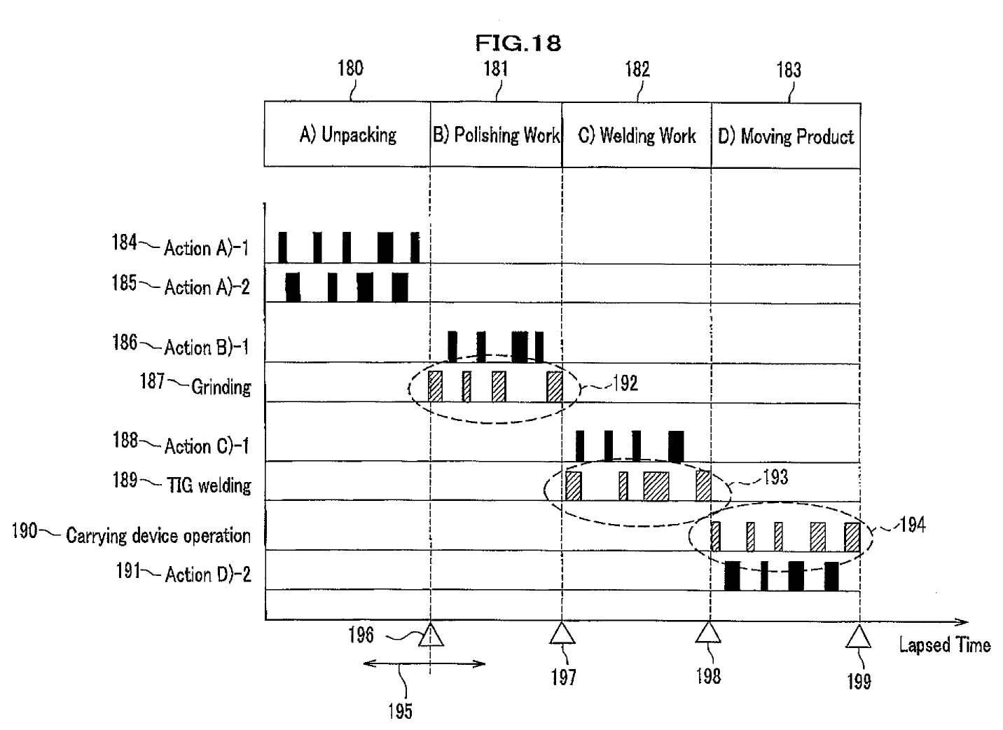

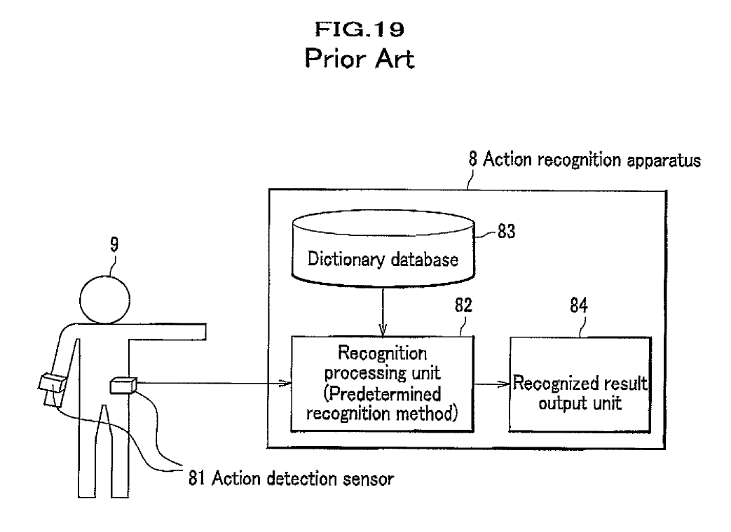

FIG. 17 is a flowchart illustrating operations of an action recognition system 300 according to the fourth embodiment. FIG. 18 is an operation conceptual diagram illustrating work contents according to the fourth embodiment. In FIG. 18, the vertical axis shows action types, and the horizontal axis shows work contents subjected to a step management in a lapsed time.

Next are described in detail the operations of the action recognition system 300 according to the fourth embodiment shown in FIG. 17, with reference to FIG. 16 and FIG. 18.

In FIG. 17, the estimation processing unit 11d obtains work types included in work instruction information on the plural-works basis from the step management device 60 (step S171).

The obtained work types are, for example, works to be done today in one day, as shown in FIG. 18, including unpackaging 180, polishing 181, welding 182, and moving product 183. It is assumed herein that the order of the work types is known, but times 196, 197, 198, 199 for delimiting each work are not yet known.

The selection processing unit 12 retrieves a characteristic action of each work from the characteristics database 23 (step S172). The characteristics database 23 stores therein a characteristic action type representative of a work. In FIG. 18, for example, “grinding” 187 is stored as a representative of a polishing work, and “TIG welding” 189, a welding work.

The characteristic action retrieved by the selection processing unit 12 and read by the characteristics database 23 is transferred to the recognition processing unit 14. The recognition processing unit 14 performs an action recognition processing based on the obtained characteristic action (step S173). The recognition processing unit 14 obtains a result of recognition and transfers the result to the recognized result output unit 15. The recognized result output unit 15 outputs the recognition result of characteristic actions 192, 193, 194 shown in FIG. 18.

The delimiting recognition processing unit 16 detects a starting time and an ending time of the characteristic action recognized by the recognition processing unit 14. That is, the delimiting recognition processing unit 16 detects a time period between the starting time and the ending time (both of which may also be referred to as delimiting times) recognized by the recognition processing unit 14, during which the characteristic action was performed (step S174). The time period between the starting time and the ending time is thus regarded as a work time period during which each work is implemented.

More specifically, the delimiting recognition processing unit 16 determines delimiting times indicated by arrowheads 196, 197, 198, 199 in FIG. 18 and transfers the determined delimiting times to the recognition processing unit 14. After that, similarly to the second embodiment, the recognition processing unit 14 performs an action recognition processing in each work time (step S175). For example, if the recognition processing unit 14 performs the action recognition processing in a work time period shown between arrowheads 196, 197, the recognition processing unit 14 performs a recognition processing targeted to actions having narrowed-down action types, that is, only those related to a polishing work.

As described above, the action recognition system 300 according to the fourth embodiment, the recognition processing unit 14 performs an action recognition based on a characteristic action type of each work contents stored in the characteristics database 23. This enables the delimiting recognition processing unit 16 to detect a delimiting time between continuous works. The delimiting recognition processing unit 16 determines delimiting times, for example, as indicated by the arrowheads 196, 197, 198, 199 in FIG. 18 and can determine a work time period. The delimiting recognition processing unit 16 can also perform an action recognition for each of the works designated at the reference numerals 184 to 191, based on narrowed-down action types, that is, only those related to the respective works. This can enhance accuracy of recognition.

In the action recognition system 300 according to the fourth embodiment, an estimated work time obtained from the step management device 60 as the work instruction information can be compared to an actual work time. The compared result can be fed back to the step management device 60, which enhances accuracy of step management made by the step management device 60.

In the action recognition system 300 according to the fourth embodiment, a delimiting time of each work is detected based on a characteristic action. However, the delimiting time may be detected using clustering or any other suitable technique.

In the fourth embodiment, description has been made assuming that, in the configuration of the action recognition system 300, the action recognition apparatus id is separate from the step management device 60. However, another configuration is also possible. The step management unit 61 and the work instruction information database 62 of the step management device 60 may be built in the action recognition apparatus 1d, which makes a single action recognition apparatus. Such a configuration can also obtain effects and advantages similar to those in the fourth embodiment.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

1. An action recognition apparatus for obtaining information from an action detection sensor attached to a subject and recognizing an action type which indicates each state of contents of an action performed by the subject, the action recognition apparatus comprising:
an action detection unit that detects an action of the subject using the information from the action detection sensor;
a storage unit that stores therein a recognition method/dictionary database in which a recognition method for recognizing information detected by the action detection unit and information indicating a characteristic of each action type referenced corresponding to the recognition method, as a dictionary, are registered;
an estimation processing unit that estimates action types of which action is to be performed by the subject and narrowing down the action types;
a selection processing unit that selects the recognition method and the dictionary using the recognition method/dictionary database, based on the action type narrowed down by the estimation processing unit; and
a recognition processing unit that performs a recognition processing of the information detected by the action detection unit based on the action types narrowed down by the estimation processing unit, using the recognition method and the dictionary selected by the selection processing unit.

2. The action recognition apparatus according to claim 1,
wherein the storage unit further comprises: a schedule information database that stores therein information on action contents scheduled in time series; and a schedule correspondence database that stores therein a correspondence relation between the action contents and an action type corresponding thereto, and
wherein the estimation processing unit obtains the action contents stored in the schedule information database and scheduled in time series, retrieves the action types corresponding to the obtained action contents from the schedule correspondence database, and obtains the retrieved action types as narrowed-down action types subjected to a recognition processing.

3. The action recognition apparatus according to claim 2,
wherein the estimation processing unit switches action contents to be recognized, based on the action contents stored in the schedule information database and scheduled in time series, retrieves action types to be newly recognized corresponding to the action contents from the schedule correspondence database, and obtains the retrieved action types as narrowed-down action types subjected to a recognition processing.

4. The action recognition apparatus according to claim 3,
wherein the storage unit further comprises a characteristics database that stores therein a characteristic action type for identifying action contents,
the action recognition apparatus further comprising a delimiting recognition processing unit that detects a delimiting time between action contents, based on the action contents scheduled in series and obtained by the estimation processing unit and based on a recognized result obtained by performing, by the recognition processing unit, a recognition processing of the characteristic action type stored in the characteristics database.

5. The action recognition apparatus according to claim 1, further comprising:
a position detection unit that obtains positional information from a position sensor attached to the subject and detecting a position of the subject; and
a position correspondence database provided in the storage unit, that stores therein a correspondence relation between the positional information of the subject and an action type of which action is performed by the subject,
wherein the estimation processing unit obtains the positional information detected by the position detection unit, retrieves action types corresponding to the obtained positional information from the position correspondence database, and obtains the retrieved action types as narrowed-down action types subjected to a recognition processing.

6. An action recognition system comprising:
a step management device that manages schedule information on action contents of which action is performed by a subject; and
an action recognition apparatus that obtains information from an action detection sensor attached to the subject and recognizing an action type which indicates each state of contents of an action performed by the subject,
the step management device and the action recognition apparatus being communicably connected to each other,
wherein the step management device comprises:
a storage unit that stores therein schedule information on action contents scheduled in time series;
a step management unit that manages the schedule information on the action contents; and
a communication unit that transmits the schedule information to the action recognition apparatus, and
wherein the action recognition apparatus comprises:
an action detection unit that detects an action of the subject, using the information from the action detection sensor;
a storage unit that stores therein
a recognition method/dictionary database in which a recognition method for recognizing information detected by the action detection unit and information indicating a characteristic of each action type referenced corresponding to the recognition method, as a dictionary, are registered, and
a schedule correspondence database in which a correspondence relation between the action contents and action types corresponding thereto is stored;
a communication unit that receives the schedule information from the step management device;
an estimation processing unit that obtains the schedule information via the communication unit and narrowing down the action types to be recognized corresponding to the action contents, by referencing the schedule correspondence database;
a selection processing unit that selects the recognition method and the dictionary using the recognition method/dictionary database, based on the action types narrowed down by the estimation processing unit; and
a recognition processing unit that performs a recognition processing of the information detected by the action detection unit, based on the action types narrowed down by the estimation processing unit, using the recognition method and the dictionary selected by the selection processing unit.

7. An action recognition system comprising:
a position detection device that obtains positional information of a subject; and
an action recognition apparatus that obtains information from an action detection sensor attached to the subject and recognizing an action type which indicates each state of contents of an action performed by the subject,
the step management device and the action recognition apparatus being communicably connected to each other,
wherein the position detection device comprises:
a position detection unit that obtains positional information from a position sensor attached to the subject and detecting a position of the subject; and
a communication unit that transmits the information to the action recognition apparatus, and
wherein the action recognition apparatus comprises:
an action detection unit that detects an action of the subject, using the information from the action detection sensor;
a storage unit that stores therein
a recognition method/dictionary database in which a recognition method for recognizing information detected by the action detection unit and information indicating a characteristic of each action type referenced corresponding to the recognition method, as a dictionary, are registered, and
a position correspondence database in which a correspondence relation between the positional information of the subject and the action types of which action is performed by the subject is stored;
a communication unit that receives the positional information from the position detection device;
an estimation processing unit that obtains the positional information of the subject via the communication unit, and narrowing down the action types corresponding to the positional information by referencing the position correspondence database;
a selection processing unit that selects the recognition method and the dictionary using the recognition method/dictionary database, based on the action types narrowed down by the estimation processing unit; and
a recognition processing unit that performs a recognition processing of the information detected by the action detection unit, based on the action types narrowed down by the estimation processing unit, using the recognition method and the dictionary selected by the selection processing unit.

8. An action recognition method used in an action recognition apparatus for obtaining information from an action detection sensor attached to a subject and recognizing an action type which indicates each state of contents of an action performed by the subject, the action recognition apparatus comprising a storage unit that stores therein a recognition method/dictionary database in which a recognition method for recognizing information from the action detection sensor and information indicating a characteristic of each action type referenced corresponding to the recognition method, as a dictionary, are registered, the action recognition method comprising the steps of:
detecting an action of the subject, using the information from the action detection sensor;
narrowing down action types of which action is performed by the subject;
selecting the recognition method and the dictionary using the recognition method/dictionary database, based on the narrowed-down action types; and
performing a recognition processing of the detected information based on the narrowed-down action types, using the selected recognition method and the dictionary.
